(19) United States
(12) Patent Application Publication
(10) Pub. No.: US 2013/0042626 A1
(43) Pub. Date: Feb. 21, 2013

(54) INTEGRATED PLANT FOR ELECTRICAL ENERGY PRODUCTION AND STORAGE

(71) Applicant: A. Sidney Johnston, Boston, MA (US)

(72) Inventor: A. Sidney Johnston, Boston, MA (US)

(21) Appl. No.: 13/209,895

(22) Filed: Aug. 15, 2011

(51) Int. Cl. F02C 3/28; F03G 6/00

(52) U.S. Cl. 60/780; 60/39.12; 60/641.8

(57) ABSTRACT

A method for operating an electrical energy storage system is described. Electrical energy is supplied to electrolyze first water to produce hydrogen and oxygen. A turbine is operated from the hydrogen and the oxygen to combine the hydrogen and the oxygen to deliver energy to the turbine by forming second water in a vapor phase in order for the turbine to operate an electric generator to generate electrical energy. The second water is condensed from the vapor phase into a liquid phase as liquid second water. The liquid second water is delivered to be electrolyzed into new hydrogen and new oxygen in order to recirculate the second water for electrolysis into new hydrogen and new oxygen. The electrical energy generated by the electric generator is distributed to customers by means of grid transmission lines.

### FIELD OF THE INVENTION

This invention relates to energy production which may be interrupted, and to storage of electrical energy for use during the interruption. For example, the conversion of solar radiation into electrical energy is interrupted at sundown until the next dawn, and the electrical energy is stored during the day for use during the night.

### BACKGROUND

Solar energy may be captured and turned into electrical energy by a number of known methods.

A first known method of capturing solar energy is the use of a reflector to focus sunshine onto a capsule containing a working fluid, allowing the heat of the focused solar energy to raise the temperature of a working fluid, and to use the heated working fluid to operate a heat engine.

Alternatively, wind may be used to turn a wind turbine and operate an attached electrical generator.

As a further alternative, photovoltaic cells may be used to convert direct sunlight into electrical energy. Again, when the Sun sets in the afternoon, no electricity is produced.

Further, as clouds blow past a solar collector of any type, the collector is alternately exposed to direct sunlight and is shaded as the wind blows clouds blow past the solar collector. This alternation of illumination and shading of the solar collector introduces an undesirable high frequency noise into the electric grid.

Both wind and solar energy are examples of intermittent energy production modalities, and both need to store the generated energy. Solar needs to store electrical energy for use at night or when shaded by moving clouds. Wind energy production needs to store energy for use when the wind is not blowing.

An additional problem which present day nuclear electric power plants have, and also fossil fuel burning electric power plants have, is that it is difficult and costly to shut down the plants at night, and then restart the plants the next morning. It would be useful to stop these electric generating plants during the night because the electric load is maximum during the daylight hours, and drops considerably during the night because of ordinary work habits of the general population. It would be useful if there were a means to utilize electrical energy produced by an ordinary nuclear electric generating plant, or an ordinary fossil fuel electric generating plant during the night. Currently, pumped hydro storage is used to help solve the problem of loss of load during nighttime. In pumped hydro storage systems, the electricity produced during the nighttime is used to operate water pumps and to pump water from a river up a mountain to a lake at the top of the mountain. Then during daytime, the water which was collected in the lake is permitted to descend back down to the level of the river and to pass through a water turbine in order to generate electricity for the daytime hours when the electric load is heavy. The pump and the water turbine are usually one mechanical unit which serves as both a pump at night, and as a water turbine during the day to generate electric power.

### SUMMARY OF THE INVENTION

The invention is an integrated plant for storing energy from intermittent energy production sources such as solar and wind electrical energy production. Water is electrolyzed by the electrical energy to produce hydrogen and oxygen gas. The hydrogen and oxygen are stored for use when electrical energy is needed. Electrical energy may be generated from the hydrogen and oxygen in several ways, including use of a gas turbine to turn an electrical generator, by a fuel cell using the hydrogen and oxygen to chemically produce electrical energy, and so forth.

Before being electrolyzed, the water must be purified. Distillation of the water is a known way to purify water. The energy required to raise the temperature of the water from ambient to 100 degrees centigrade to boil the water is referred to as “heating energy”. The energy required to convert the liquid water into gas water, that is steam, is referred to as latent heat of the water. The vaporized water is then cooled and condensed into pure liquid water, and the pure liquid water is directed into an electrolyser. The energy required to purify the water is a large part of the cost of storage of electrical energy by electrolysis.

The integrated plant burns the hydrogen with the oxygen produced by electrolysis in a gas turbine. Water is produced by the burning. The water produced by burning is captured and is first filtered and then returned to be used in another round of electrolysis.

The problem of loss of load during the night on present day electric power grids is solved by the present invention by using any excess electrical energy produced during nighttime by nuclear or fossil fuel electric power plants by using the excess electricity to electrolyze water in order to produce hydrogen and oxygen. Then, during daylight time, the hydrogen and oxygen are recombined in a hydrogen-oxygen turbine to generate electricity during high load times during daylight hours.

The presently disclosed system may be used for electrical energy storage for energy production methods which have the characteristic of intermittent energy production. For example, solar collectors cease working when the sun sets, when clouds shade the solar collector, etc. Either photovoltaic or the heat engine such as a Stirling Engine are intermittent energy production techniques. Wind electrical energy production is intermittent as sometimes the wind blows, and sometimes the wind does not blow. Tidal energy production is another intermittent electrical energy production method, as it produces energy as the tides are either rising, or falling, etc. All of these intermittent energy production methods need electrical energy storage, and the use of electrolysis of water to produce hydrogen and oxygen can be usefully employed to provide the electrical energy storage needed.

In the drawings, like reference characters generally refer to the same parts throughout the different views. Also, the drawings are not necessarily to scale, emphasis instead generally being placed upon illustrating the principles of the invention.

### BRIEF DESCRIPTION OF THE DRAWINGS

FIG. 1 is a line drawing showing a battery plant sufficient to support the electric grid for days.

FIG. 2 is a block drawing showing an alternative internal operation of a battery plant according to the invention.

FIG. 3 is a block drawing showing an alternative operation of a battery plant according to the invention.

FIG. 4 is a flow chart of an exemplary integrated battery plant according to the invention.

FIG. 5 is a block drawing of a gas turbine with steam injection.

FIG. 6 is a block drawing of a solar energy collector plant with a battery plant sufficient to support the electric grid during absence of sunlight.

FIG. 7 is a block drawing of a wind energy plant with a battery plant sufficient to support the electric grid during absence of wind.

FIG. 8 is an overall map of an electric grid with transmission lines in the United States of America (USA), with many sources of electrical energy, and with many customers for the electrical energy.

### DETAILED DESCRIPTION

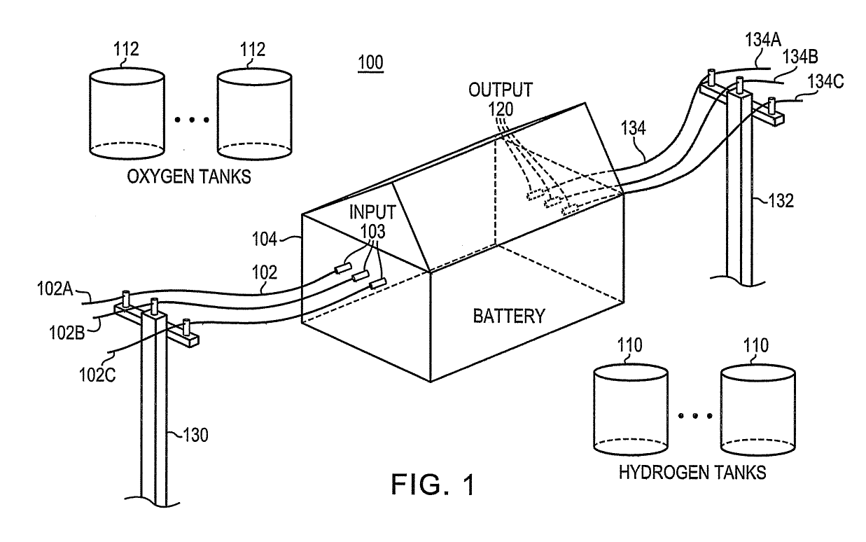

Turning now to FIG. 1, a battery system 100 for an electrical high voltage transmission line is shown. A high voltage input line 102 connects to input terminals 103 of building 104 housing an electrical energy storage system. The electrical energy storage system has an electrolysis system (not shown in FIG. 1) which converts electrical energy supplied by high voltage input line 102 into hydrogen and oxygen, and the hydrogen is stored in tanks 110, and the oxygen is stored in tanks 112. A gas turbine system (not shown in FIG. 1) driven by hydrogen stored in tanks 110 and by oxygen stored in tanks 112, along with a multistage steam turbine (not shown in FIG. 1) generates electrical energy using steam created by chemically reacting the hydrogen and oxygen within the gas turbine system to create water at high temperature. The electrical energy is delivered at output terminals 120 of the battery system 100. High voltage transmission tower 130 supports input line 120, and high voltage transmission tower 132 supports the output line 134. Input line 102 and output line 134 are illustrated as three conductor electrical transmission lines to illustrate the point that battery system 100 is designed for operation at transmission grid voltages and currents in order to serve as a battery system 100 for grid level quantities of electrical energy. Grid level quantities of electrical energy are quantities normally supplied by three phase transmission lines for which it is convenient to measure the quantities in units of kilowatt hours and, alternatively, in units of megawatt hours. The three phase lines are traditionally conducting cables made of copper or aluminum, and steel, and are supported in the open air by transmission towers 130, 132. Alternatively, the transmission lines 102, 134 may be constructed of superconducting wires, and may be cooled by liquid nitrogen to temperatures near 77 Kelvin, or may be further cooled by liquid hydrogen or liquid helium. Voltages between polyphase conductors 102A, 102B, and 102C may be in the range of a few kilovolts through a few million volts. Likewise, output polyphase conductors 134A, 134B, and 134C may be in the range of a few kilovolts through a few million volts. Input conductors 102A, 102B, 102C and output conductors 134A, 134B, 134C may carry currents limited only by the temperatures which the conductors can bear, for example currents in the range of several thousand amperes for copper or aluminum and steel overhead wires. Superconducting wires are presently under development, but it is anticipated that conductors made of superconductor materials will carry currents limited only by the superconductor nature of the superconductor materials.

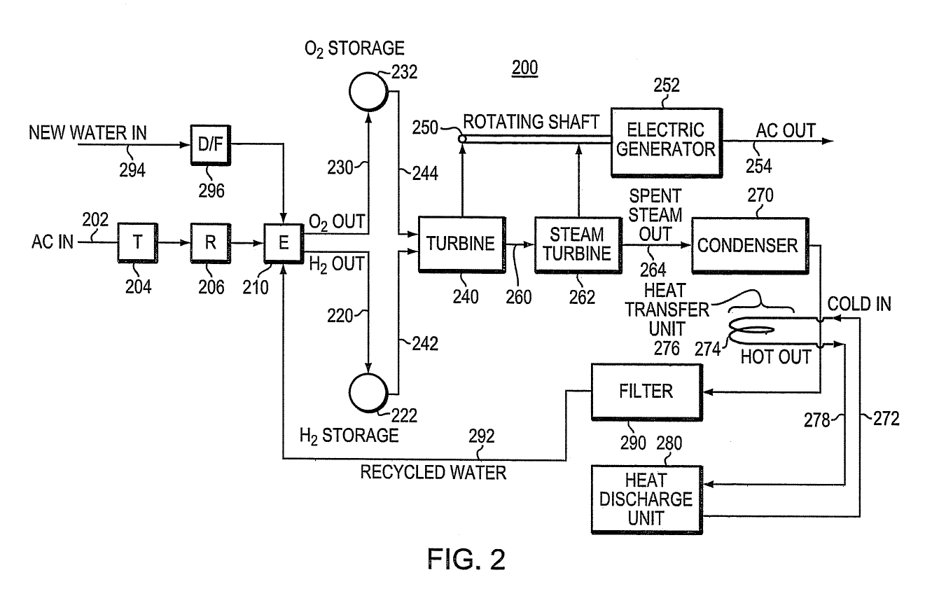

Turning now to FIG. 2, an electrolysis system 200 for serving as a battery for grid level energy storage is shown. In the exemplary system shown in FIG. 2, the input electrical energy enters through “AC in” electrical conducting line 202 which brings alternating current from the electrical grid into electrolysis system 200. For example, “AC in” line 202 could be polyphase input electrical line 103 shown in FIG. 1. Grid level power brought into electrolysis system 200 may, in an exemplary embodiment, use illustrative voltages between 100,000 Volts and one million Volts with an illustrative current flow of between 1,000 Amperes and 10,000 Amperes.

The alternating current arriving along electrical conducting line 202 first goes to transformer “T” 204 which converts the electrical energy to a convenient voltage. The output of transformer 204 then connects to rectifier “R” 206. Rectifier 206 converts the polyphase alternating current into direct current. The direct current from rectifier 206 is then directed to electrolyzer “E” 210.

Electrolyzer 210 applies the direct current from rectifier 206 to water to produce hydrogen and oxygen by electrolysis. Many commercial electrolyzers are sold to perform electrolysis of water, and several commercial models will be further described hereinbelow.

Gaseous hydrogen is collected from electrolyzer 210 and is directed by hydrogen piping line 220 to hydrogen storage system 222. Hydrogen storage system 222 may be designed to store gaseous hydrogen at a convenient pressure. Alternatively, hydrogen storage system 222 may be designed to liquefy gaseous hydrogen produced by electrolyzer 210, and the hydrogen stored as liquid hydrogen by hydrogen storage system 222. Factors such as cost of liquefying the hydrogen, cost of a pressure tank for gaseous hydrogen, technical complexity of liquefaction of hydrogen versus simply storing of gaseous hydrogen at the convenient pressure, etc. must be considered in the design of hydrogen storage system 222.

Oxygen is collected from electrolyzer 210 and is directed by oxygen piping line 230 to oxygen storage system 232. Oxygen storage system 232 may be designed to store gaseous oxygen at a convenient pressure. Alternatively, oxygen storage system 232 may be designed to liquefy gaseous oxygen produced by electrolyzer 210, and the oxygen stored as liquid oxygen by oxygen storage system 232. Factors such as cost of liquefying the oxygen, cost of a pressure tank for gaseous oxygen, technical complexity of liquefaction of oxygen versus simply storing of gaseous oxygen at the convenient pressure, etc. must be considered in the design of oxygen storage system 232.

Turbine 240 receives hydrogen through hydrogen pipe 242 from hydrogen storage system 222, and also turbine 240 receives oxygen through oxygen pipe 244 from oxygen storage system 232. The hydrogen and oxygen received by turbine 240 chemically combine to form water and to release chemical energy from the reaction forming water. The chemical energy released in forming water is delivered to rotating shaft 250, and rotating shaft 250 operates electric generator 252 to generate electrical energy which is conducted by wires 254. Wires 254 can be, for example, connected to output connectors 120 to provide output as polyphase alternating current to the electric power distribution grid.

Further, water produced by chemical reaction of hydrogen and oxygen within turbine 240 is conducted by pipe 260 to steam turbine 262. The water produced within turbine 240 will be in gaseous form, that is the water will be steam, and the steam will be at a sufficiently high temperature to operate steam turbine 262. Steam turbine 262 is also connected to a mechanical shaft which is caused to rotate by steam turbine 262, and the rotating mechanical shaft also operates an electric generator to produce electricity directed to electric output wires 254. As shown in FIG. 2, steam turbine 262 is mechanically coupled to rotating shaft 250 of turbine 240, and both turbine 240 and steam turbine 262 supply energy to rotating shaft 250 to operate electric generator 252.

An exemplary method for setting up turbine 240, steam turbine 262, and electric generator is to align the turbines and electric generator so that all operate on a single rotating shaft which is powered by the turbines 240 262 and delivers mechanical power to electric generator 252.

Alternatively, turbine 240 can operate a first electric generator (not shown in FIG. 2) and steam turbine 262 can operate a second electric generator (not shown in FIG. 2) to operate separate electric generators (not shown in FIG. 2), and the output of the separate electric generators can be combined electrically (not shown in FIG. 2) to produce an electric output such as is conducted by output terminals 120 to an electric power grid represented by wires 134A 134B and 134C, as shown in FIG. 1.

Exemplary turbine 240 may be a gas turbine similar to a turbine operated using air and natural gas, or air and methane, or air and another hydrocarbon.

As an alternative turbine 240, steam may be injected into turbine 240 in order to adjust the mass of steam passing through turbine 240. By injecting steam, the ratio of energy released by chemical combination of hydrogen and oxygen may be adjusted relative to the mass of steam to provide a desired balance in turbine 240.

Alternatively, liquid hydrogen and liquid oxygen may be employed to operate exemplary turbine 240. When liquid hydrogen and liquid oxygen are used as fuel for turbine 240, then turbine 240 will resemble the turbines used as motors for rockets such as were used to launch spacecraft. However, the cost of turbine 240 must be carefully considered along with the torque needed for steady state operation to supply the electric power grid with steady electric power.

The spent steam from steam turbine 262 is conducted by pipe 264 to condenser 270. Condenser 270 cools the spent steam from steam turbine 262 by circulating cooling water, where cold cooling water 272 enters heat exchanger piping 274 in heat transfer unit 276. The cold cooling water entering by pipe 272 is heated and exits through hot output pipe 278. The hot cooling water is conducted by hot output pipe 278 to heat discharge unit 280 where the cooling water is cooled. Cold cooling water is returned by cold water pipe 272 to re-circulate through heat transfer unit 276. Heat discharge unit may be, for example, a cooling tower using evaporation to cool the hot water brought in by hot water pipe 278, or, for example, heat discharge unit may be a heat exchanger which is cooled by a river, the ocean, or a lake, etc., or still as a further example, heat discharge unit 280 may be any convenient heat discharge machinery.

The spent steam conducted by pipe 264 to condenser 270 is cooled to be liquid water which is conducted from condenser 270 to filter 290. Filter 290 removes any contaminants which may have dissolved into the water as it circulated from liquid water in electrolyzer 210 to stored hydrogen in hydrogen storage system 222 and into oxygen stored in oxygen storage system 232, and then combined in turbine 240 to become steam directed into steam turbine 262, and then conducted to condenser 270 where it was cooled to become liquid water. After passing through filter 290 the water is conducted as recycled water by pipe 292 to electrolyzer 210 where it once again is electrolyzed into hydrogen and oxygen.

New water is directed into electrolyzer 210 through pipe 294 to purifying system 296. New water is needed to: first, supply the system with enough water to produce hydrogen and oxygen, and to operate the turbine 240 and the steam turbine 262; and secondly, to make up water lost from the system during routine operation of the turbine 240 and stem turbine 262. For example, the new water may be drawn from the ocean, from surface water such as a river, lake, pond, etc., or may be drawn from an underground source of water by, for example, a well. Purifying system 296 is designed to purify the incoming new water so that it is suitable for use in electrolyzer 210. For example, purifying system 296 may be a distillation apparatus in which the water is boiled and the steam so produced is condensed to liquid water. Alternatively, purifying system 296 may use filters to remove dissolved impurities in the new water. The expense of boiling the water to remove, for example, ocean salt, versus the expense of a filter system, and the efficacy of such filter systems, must be considered in designing purification system 296.

The cost of distillation in purification system 296, as measured in energy units, requires supplying heat to raise the water to boiling temperature, and then supplying the heat of vaporization to the water. This cost is saved by recycling purified water through condenser 270, filter 290, and pipe 292 which delivers recycled water to electrolyzer 210. The use of recycled water supplied by pipe 292 to electrolyzer 210 avoids the cost of purifying all water utilized by the electrolyzer 210, as only the new water brought into the system to make up for loss of water during the recycling process need be distilled, on a routine basis.

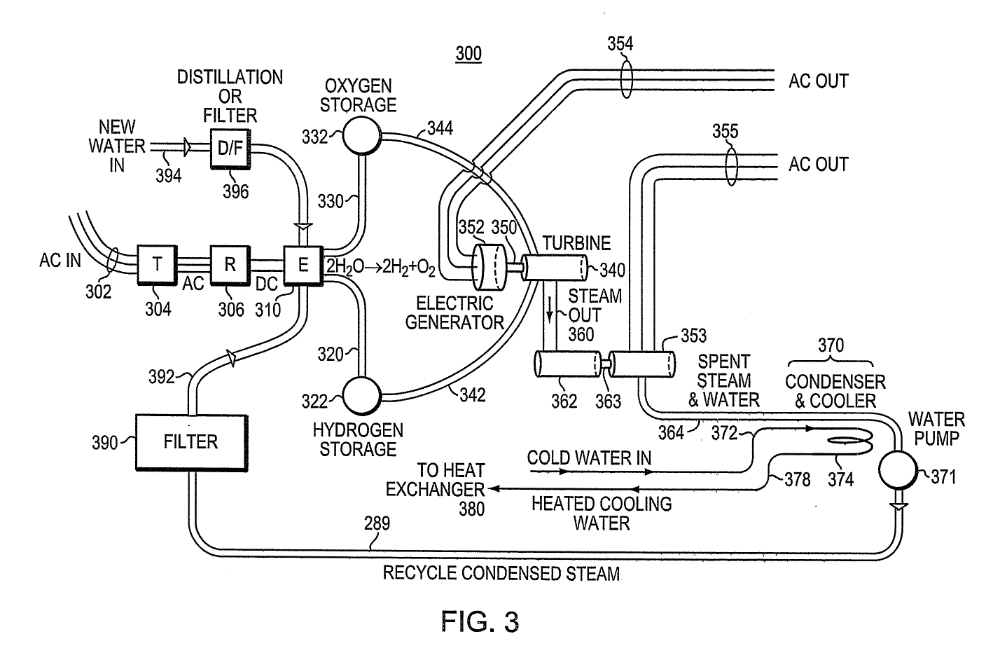

Turning now to FIG. 3, exemplary electrolysis system 300 is shown. Electrolysis system 300 may serve as a battery for grid level energy storage. In the exemplary system shown in FIG. 3, the input electrical energy enters through “AC in” electrical conducting lines 302. Electrical conducting lines 302 are illustrated as bringing three phase electrical energy into electrolysis system 300. Grid level power brought into electrolysis system 300 may, in an exemplary embodiment, use illustrative voltages between 100,000 Volts and one million Volts with an illustrative current flow of between 1,000 Amperes and 10,000 Amperes.

The alternating current arriving along electrical conducting line 202 first goes to transformer “T” 304 which converts the electrical energy to a convenient voltage. The output of transformer 304 then connects to rectifier “R” 306. Rectifier 306 converts the three phase alternating current into direct current. The direct current from rectifier 306 is then directed to electrolyzer “E” 310.

Electrolyzer 310 applies the direct current from rectifier 306 to water to produce hydrogen and oxygen by electrolysis. Many commercial electrolyzers are sold to perform electrolysis of water, and several commercial models will be further described hereinbelow.

Gaseous hydrogen is collected from electrolyzer 310 and is directed by hydrogen piping line 320 to hydrogen storage system 322. Hydrogen storage system 322 may be designed to store gaseous hydrogen at a convenient pressure. Alternatively, hydrogen storage system 322 may be designed to liquefy gaseous hydrogen produced by electrolyzer 310, and the hydrogen stored as liquid hydrogen by hydrogen storage system 322. Factors such as cost of liquefying the hydrogen, cost of a pressure tank for gaseous hydrogen, technical complexity of liquefaction of hydrogen versus simply storing of gaseous hydrogen at the convenient pressure, etc. must be considered in the design of hydrogen storage system 322.

Oxygen is collected from electrolyzer 310 and is directed by oxygen piping line 330 to oxygen storage system 332. Oxygen storage system 332 may be designed to store gaseous oxygen at a convenient pressure. Alternatively, oxygen storage system 332 may be designed to liquefy gaseous oxygen produced by electrolyzer 310, and the oxygen stored as liquid oxygen by oxygen storage system 332. Factors such as cost of liquefying the oxygen, cost of a pressure tank for gaseous oxygen, technical complexity of liquefaction of oxygen versus simply storing of gaseous oxygen at the convenient pressure, etc. must be considered in the design of oxygen storage system 332.

Turbine 340 receives hydrogen through hydrogen pipe 342 from hydrogen storage system 322, and also turbine 340 receives oxygen through oxygen pipe 344 from oxygen storage system 332. The hydrogen and oxygen received by turbine 340 chemically combine to form water and to release chemical energy from the reaction forming water. The chemical energy released in forming water is delivered to rotating shaft 350, and rotating shaft 350 operates electric generator 352 to generate electrical energy which is conducted by wires 354. Wires 354 are illustrated as carrying three phase currents. Wires 354 can be, for example, connected to output connectors 120 to provide output as three phase alternating current to the electric power distribution grid. Grid level power brought out of electrolysis system 300 by three phase conductors 354 may, in an exemplary embodiment, be delivered to transformers (not shown in FIG. 3) supplying illustrative voltages between 100,000 Volts and one million Volts with an illustrative current flow of between 1,000 Amperes and 10,000 Amperes.

Further, water produced by chemical reaction of hydrogen and oxygen within turbine 340 is conducted by pipe 360 to multi-stage steam turbine 362. The water produced within turbine 340 will be in gaseous form, that is the water will be steam, and the steam will be at a sufficiently high temperature to operate multi-stage steam turbine 362. Multi-stage steam turbine 362 is connected to mechanical shaft 363 which is caused to rotate by multi-stage steam turbine 362, and the rotating mechanical shaft 363 operates electric generator 353 to produce electricity directed to electric output wires 355. Electric output wires 355 are illustrated as carrying three phase electric power to an electric grid as illustrated in FIG. 1 by grid wires 134A 134B 134C. Grid level power brought out of electrolysis system 300 by three phase conductors 354 and 355, in an exemplary embodiment of the invention, may be delivered to transformers (not shown in FIG. 3) supplying illustrative electric power between 1,000 megawatts and 3,000 megawatts.

The spent steam from steam turbine 362 is conducted by pipe 364 to condenser 370. Condenser 370 cools the spent steam from steam turbine 362 by circulating cooling water, where cold cooling water 372 enters heat exchanger piping 374 in condenser 370. The cold cooling water entering by pipe 372 is heated and exits through hot output pipe 378. The hot cooling water is conducted by hot output pipe 378 to a heat exchanger (not shown in FIG. 3) where the heated cooling water in pipe 378 is cooled. Cold cooling water is returned by cold water pipe 372 to re-circulate through condenser 370. The heat exchanger 380 (not shown in FIG. 3) may be, for example, a cooling tower using evaporation to cool the hot water brought in by hot water pipe 378, or, for example, the heat exchanger 380 may be cooled by a river, the ocean, or a lake, etc., or still as a further example, the heat exchanger 380 may be any convenient heat discharge machinery.

The spent steam conducted by pipe 364 to condenser 370 is cooled to be liquid water which is conducted from condenser 370 with the aid of water pump 371 through pipe 289 to filter 390. Filter 390 removes any contaminants which may have dissolved into the water as it circulated from liquid water in electrolyzer 310 to stored hydrogen in hydrogen storage system 322 and into oxygen stored in oxygen storage system 332, and then combined in turbine 340 to become steam directed into multi-stage steam turbine 362, and then conducted to condenser 370 where it was cooled to become liquid water. After passing through filter 390 the liquid water is conducted as recycled water by pipe 392 to electrolyzer 310 where it once again is electrolyzed into hydrogen and oxygen.

New water is directed into electrolyzer 310 through pipe 394 to purifying system 396. New water is needed to: first, supply the system with enough water to produce hydrogen and oxygen, and to operate the turbine 340 and the multi-stage steam turbine 362; and secondly, to make up water lost from the system during routine operation of the turbine 340 and multi-stage stem turbine 362. For example, the new water may be drawn from the ocean, from surface water such as a river, lake, pond, etc., or may be drawn from an underground source of water by, for example, a well. Purifying system 396 is designed to purify the incoming new water so that it is suitable for use in electrolyzer 310. For example, purifying system 396 may be a distillation apparatus in which the water is boiled and the steam so produced is condensed to liquid water. Alternatively, purifying system 396 may use filters to remove dissolved impurities in the new water. The expense of boiling the water to remove, for example, ocean salt, versus the expense of a filter system, and the efficacy of such filter systems, must be considered in designing purification system 396.

The cost of distillation in purification system 396, as measured in energy units, requires supplying heat to raise the water to boiling temperature, and then supplying the heat of vaporization to the water. This cost is saved by recycling purified water through condenser 370, filter 390, and pipe 392 which delivers recycled water to electrolyzer 310. The use of recycled water supplied by pipe 392 to electrolyzer 310 avoids the cost of purifying all water utilized by the electrolyzer 310, as only the new water brought into the system to make up for loss of water during the recycling process need be distilled, on a routine basis.

### Efficiency Estimate of Electrolysis Battery System

Multi-stage steam turbine 362 is referred to as a “multi-stage steam turbine” to illustrate that the design of the turbine is implemented to thermodynamically extract as much heat energy in steam delivered to the turbine as is thermodynamically and mechanically possible. The efficiency of a steam turbine, and a multi-stage steam turbine, is frequently modeled as a Carnot efficiency dependent only on the input temperature of the working fluid, in the illustrated case, the temperature of the input steam and the output temperature of the working fluid. The Carnot efficiency is then multiplied by a “mechanical efficiency”. The mechanical efficiency is used to relate the efficiency of the actual mechanical design to the Carnot efficiency. For example, the efficiency of the turbine may be modeled as:

efficiency (turbine)=(Carnot efficiency)*(mechanical efficiency).

The Carnot efficiency is given as:

efficiency (Carnot)=1−(Temperature out)/(Temperature in)

As a model of the electrolysis battery system, it is assumed that the flame temperature of the hydrogen oxygen mixture in the gas turbine is limited by materials from which the turbine is constructed. A hydrogen-oxygen flame is expected to be high enough to melt most metals or composite materials used to make turbines. Accordingly, the operation of the gas turbine and the steam turbine is modeled simply by assuming that the output steam temperature from the hydrogen-oxygen turbine (turbine 240, turbine 340) is approximately 2,000 Kelvin. The hydrogen-oxygen turbine and the steam turbine (turbine 262, turbine 362) operate substantially in parallel to convert hydrogen and oxygen into electrical energy. Only the efficiency of the steam turbine will be considered next, the actual efficiency will be somewhat higher than calculated hereinbelow because of the electrical energy produced by the hydrogen-oxygen turbine 240, 340).

Accordingly, the steam temperature into the multi-stage steam turbine may be around 2,000 Kelvin, and the output temperature may be near the boiling temperature of water at atmospheric pressure, or about 300 Kelvin. The Carnot efficiency is than:

efficiency (Carnot)=1−(300/2000)=0.85

The mechanical efficiency, when the best multistage design of a steam turbine is used may be about 90%, to give an efficiency of the turbine of approximately:

$$\begin{matrix}efficiency ( turbine ) = ( Carnot efficiency ) * ( mechanical efficiency ) \\ = 0.85 * 0.90 \\ = 0.77\end{matrix}$$

That is a 77% efficiency of the multistage steam turbine 362. For steam turbine 262, an equal efficiency may be achieved.

To determine an overall efficiency of electrolysis system 200 and electrolysis system 300 the efficiency of the electrolyzer must be considered.

It is shown hereinbelow that the energy efficiency of converting electrical energy into hydrogen and oxygen gas chemical bond energy is expected to be about 66%, that is an efficiency of 0.66.

The overall efficiency of energy storage in electrolysis system 200 or electrolysis system 300 is then expected to be given by:

$$\begin{matrix}efficiency ( electrolysis storage ) = = ( efficiency to make H and O ) * \\ ( \begin{matrix}efficiency to convert H \\ and O into electricity\end{matrix} ) \\ = 0.66 * 0.77 \\ = 0.55\end{matrix}$$

Accordingly, for every kilowatt hour of electrical energy which goes into the “battery” of FIG. 1 through input wires 102A, 102B, 102C there is produced ½ kilowatt hour output to the grid through output wires 134A, 134B, 134C.

Even if the thermodynamic estimates given herein are somewhat in error, an efficiency of at least 30% is expected. A 30% efficiency means that three kilowatt hours of energy must be delivered to the battery of FIG. 1 in order to deliver one kilowatt hour to the grid through output lines 134A, 134B, 134C.

However, the efficiency of the hydrogen-oxygen turbine has not been considered in the above estimate, and since the hydrogen-oxygen turbine operates in parallel with the steam turbine, the overall efficiency of the battery may be higher than predicted herein. Detailed design considerations will determine the overall efficiency of the battery illustrated in FIG. 1, FIG. 2, and FIG. 3.

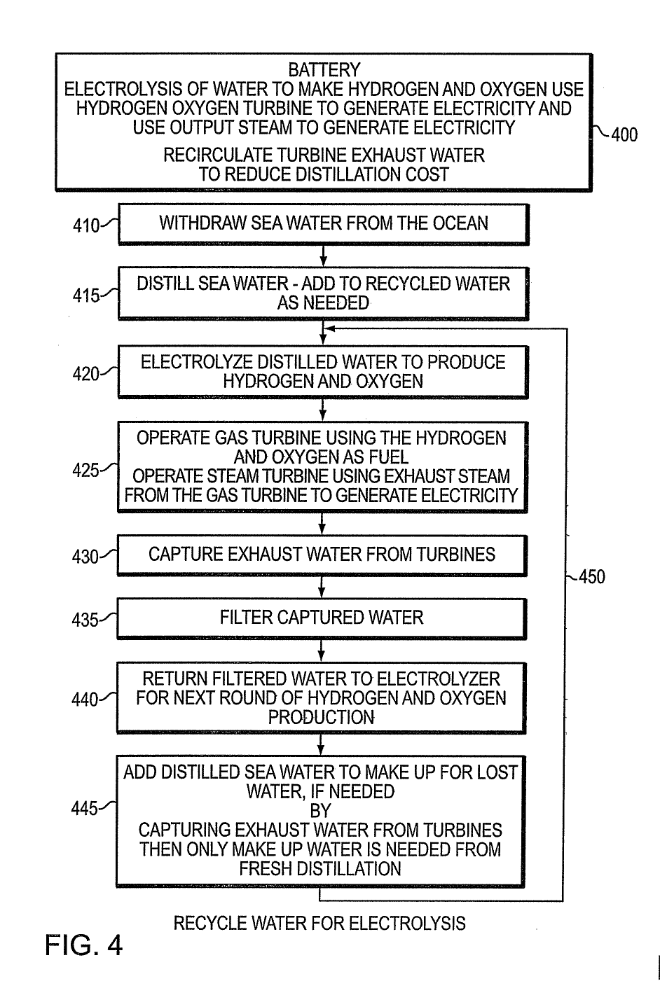

Turning now to FIG. 4, there is shown an exemplary flow chart for the battery system of FIG. 1, FIG. 2, and FIG. 3. Title 400 of the flow chart indicates that turbine exhaust water is recycled in order to avoid the cost in energy of using only freshly distilled water in the electrolyzer 210, 310. Title 400 states: “Electrolysis of water to make hydrogen and oxygen”; “use hydrogen oxygen turbine to generate electricity”; “and use output steam to generate electricity”; “recirculate turbine exhaust water”; “to reduce distillation cost”.

At block 410 sea water is first withdrawn from an ocean. In an alternative embodiment of the invention, water could be withdrawn from a river, a lake, an underground supply of water by use of a well, or from some other convenient source of water. Block 410 uses the exemplary source of “ocean” water to indicate that the heavy content of salts by ocean water may be successfully employed in the present invention.

At block 415 the input water, in this particular example from an ocean, is next distilled in order to produce water pure enough to use in an electrolysis apparatus.

At block 420 the distilled water is electrolyzed in order to chemically decompose the water to produce hydrogen gas and oxygen gas. The hydrogen gas and oxygen gas may then be stored for future use at a convenient time.

At block 425 a gas turbine, referred to as a “hydrogen-oxygen” turbine is operated using the hydrogen gas and the oxygen gas in order to produce electricity. The hydrogen and oxygen are chemically combined to produce water, and the temperature of the water is sufficiently high to be in the gaseous state as steam, referred to as “output steam” from the hydrogen-oxygen turbine. The output steam is then used as input steam into a steam turbine in order to produce more electricity.

At block 430 the steam exhausted from the steam turbine is then captured and condensed into liquid state water, and is then referred to as “captured water”.

At block 435 the captured water is filtered in order to remove any impurities which have become dissolved or entrained by the captured water. For example, small bits of the turbines may wear or corrode, and become either dissolved or entrained in the captured water. Further, considerable piping and valves are needed to control the flow of the hydrogen, the flow of the oxygen, and the flow of steam through the turbine system. Bits and pieces of the piping and valves can become dissolved or entrained in the flow of captured water. The filter of block 435 removes as much of the impurities which have been entrained or dissolved into the captured water as necessary in order to produce water of sufficient purity to return to the electrolysis step.

At block 440 the captured water is returned to the electrolyzer for another round of electrolysis for production of hydrogen gas and oxygen gas.

At block 445 newly distilled ocean water is added to the captured water to make up for any water lost in the electrolyzer, the hydrogen-oxygen turbine, the steam turbine, and the condensing system which captures the exhaust water and returns the captured water to the electrolyzer. The newly distilled water is referred to as “make up water”.

Path 450 transfers the captured water and the make up water to the electrolysis step at block 420 in order to again convert the liquid water into gaseous hydrogen and gaseous oxygen in order to generate more electricity at step 425.

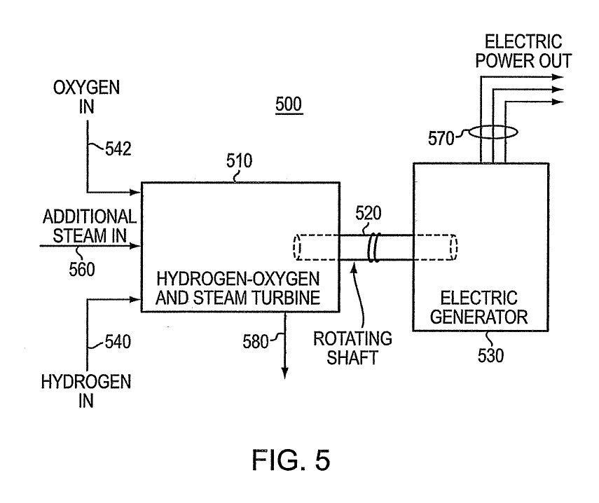

Turning now to FIG. 5, there is shown a turbine system 500. Turbine system 500 illustrates a combination hydrogen-oxygen and steam turbine 510 operating a single rotating shaft 520, and the rotating shaft 520 operates an electric generator 530. The hydrogen-oxygen and steam turbine 510 receives a flow of hydrogen gas through pipe 540 and receives a flow of oxygen gas through pipe 542. The hydrogen and oxygen react chemically within turbine 510 to produce water at high temperature and to operate rotating shaft 520 to produce mechanical rotational motion. In the event that it is desirable for mechanical operation of turbine 510 to use more mass of water than is provided by the reaction of the hydrogen arriving through pipe 540 and oxygen arriving through pipe 542, additional steam is injected into turbine 510 through pipe 560. Rotating shaft 520 drives a rotor (not shown in FIG. 5) in electric generator 530 in order to produce electric power output, as indicated by wires 570. As an exemplary embodiment of the invention, wires 570 are shown as three wires to indicate a polyphase output circuit. For example, a three phase output circuit is commonly employed as the polyphase output circuit in electric generators for powering the electric grid for supplying electric power to customers over a wide geographical area.

The energy supplied by electric generator 530 through its output wires 570 is supplied by the chemical energy released by the chemical reaction of the hydrogen and oxygen supplied by pipe 540 and by pipe 542, and a “reaction mass” of water by so adjusting the energy supplied to turbine 510 by the chemical reaction between the hydrogen and the oxygen. In the event that it is desirable for a mass greater than the “reaction mass” to be used to operate the turbine 510, the additional needed mass is supplied by steam input as “additional stream” through pipe 560.

Output steam from turbine 510 passes through pipe 580. The output steam from pipe 580 is then directed to a further steam turbine (not shown in FIG. 5) such as steam turbine 262 shown in FIG. 2, or steam turbine 362 shown in FIG. 3. Output electric power from the further turbine supplied with steam by pipe 580 is then part of the electric power output of the turbine system illustrated in FIG. 5, for example as output on wires 355 as shown in FIG. 3.

Alternatively, the output of the electric generator 530, or the electric generator 252 shown in FIG. 2, or the electric generators 352 and 353 shown in FIG. 3, may be direct current (DC) in order to drive a direct current transmission line. A further alternative is to generate polyphase alternating current by rotational motion within electric generators such as 252, 352, 353, and 530 and then use transformers to raise the polyphase current to high voltage, and then rectify the high voltage polyphase current in order to supply a long direct current transmission line. Such a direct current transmission line is convenient in that phase matching that is required with polyphase transmission lines is not necessary with the direct current transmission lines.

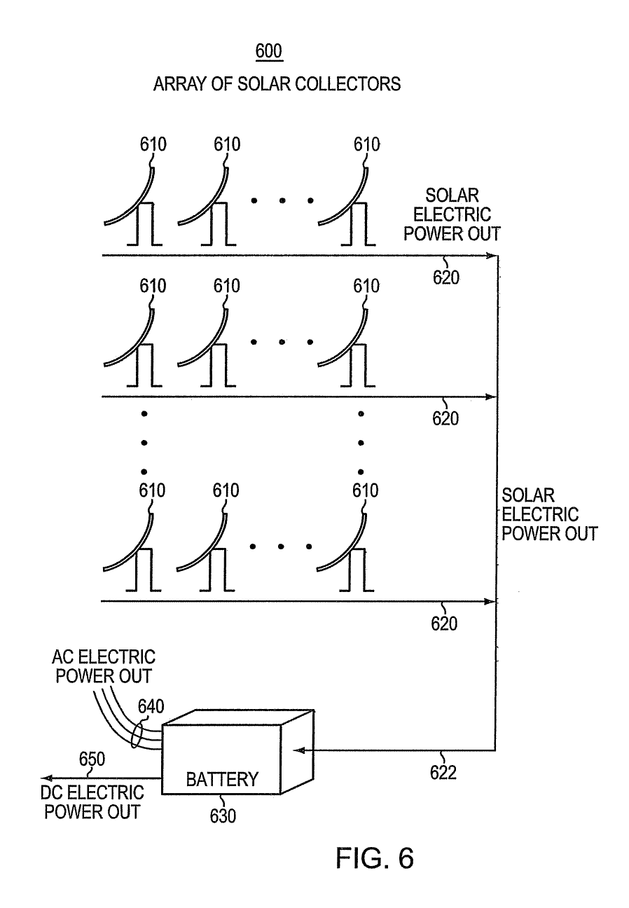

Turning now to FIG. 6, there is shown a solar electrical energy collection system 600. Solar electric power generators 610 are shown as a large array of solar collectors. There are many forms of solar electrical energy collection systems, and all types of solar electric power collectors 610 are meant to be illustrated in FIG. 6. For example, solar electric power generators 610 includes semi-conductor solar cells such as are commonly deployed on rooftops or as free standing panels, parabolic reflectors which concentrate solar energy on a thermodynamic working fluid such as a Stirling engine and the Stirling causes an electric generator to rotate and generate electric power, trough shaped solar reflectors which heat a working fluid which also operates a heat engine to drive a rotating electric power generator, and all other types of solar generators. The electric output of an array of solar electric power generators 610 is collected by electric conducting wires 620, and the output of all of the solar electric power generators 610 is collected by electric conductor 622. Electric conductor 622 delivers the solar electric power to battery 630. For example, battery 630 may be near the array of solar electric power generators, and the electric power delivered by electric conductor 622 be in the form of direct current. In other cases, it may be more convenient to transmit the solar generated electric power over distances of many miles, for example, a few thousand miles, and to transmit the electric power by polyphase alternating current on electric conductors 622.

Battery 630 is substantially battery 104 shown in FIG. 1, with internal operation as electrolysis system 200 or electrolysis system 300. Hydrogen and oxygen gas are produced by electrolysis of water and the hydrogen is stored in hydrogen tanks 110, and the oxygen is stored in oxygen tanks 112, as illustrated in FIG. 1.

One problem with solar electric power is that when the Sun sets the light go out. This problem is solved by the present invention by storing sufficient hydrogen and oxygen to operate the turbines in the battery 104 to keep the electric power grid operating all night. Further, in a system wide design, enough hydrogen and oxygen are stored to operate the turbines of battery 104 for several weeks, in order to have electric power during any contingency such as heavy cloud cover, etc.

Battery 630 is connected through electrical conductors 640 to a polyphase alternating current electric grid which supplies electric power to a wide geographical area. Alternatively, battery 630 is connected to a direct current transmission line to an electric grid for distribution of electric power to a wide geographical area.

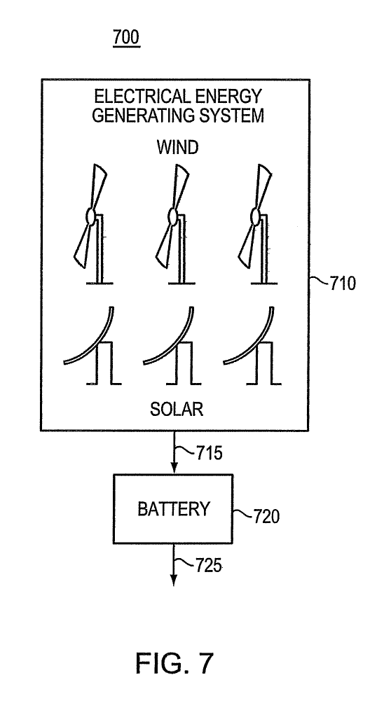

Turning now to FIG. 7, a wind power electric generating system 700 is illustrated. Wind farms are illustrated by block 710. For example, wind farms may be electric generating windmills located along mountain ridges, in the Great Plains states of The USA, along coastlines of continents where steady winds blow, offshore in shallow areas of oceans near coastlines, etc. The wind farm 710 connects to battery 720 through electrical conductors 715.

Battery 720 is substantially battery 104 shown in FIG. 1, with internal operation as electrolysis system 200 or electrolysis system 300. Hydrogen and oxygen gas are produced by electrolysis of water and the hydrogen is stored in hydrogen tanks 110, and the oxygen is stored in oxygen tanks 112, as illustrated in FIG. 1.

Battery 720 is designed to have sufficient electric storage capacity, by storing sufficient hydrogen and oxygen, to maintain operation of the electric grid for time intervals for which it can be reasonably expected that the wind will not blow to operate wind farm 710.

Battery 720 is connected by electrical conductors 725 to an electric grid used to deliver electric power to customers over a wide geographical area.

As an example, battery 630 shown in FIG. 6 and battery 720 are connected into a nationwide grid to supply electrical energy to the United States. For example, the solar collector array may be in the United States Southwest dessert where sunlight is abundant, and the battery 630 located near a coast line where ocean water is abundant to supply the electrolysis apparatus of battery 630. As a further example, wind farm 710 may be located on mountain ridges, the Great Plains, or along continental coastlines, and the battery 720 located near convenient sources of adequate water.

It is prudent to establish solar collector arrays in numerous places and to establish wind farms in numerous places, so that at least some of the time some of the installations will be operational and producing electrical energy.

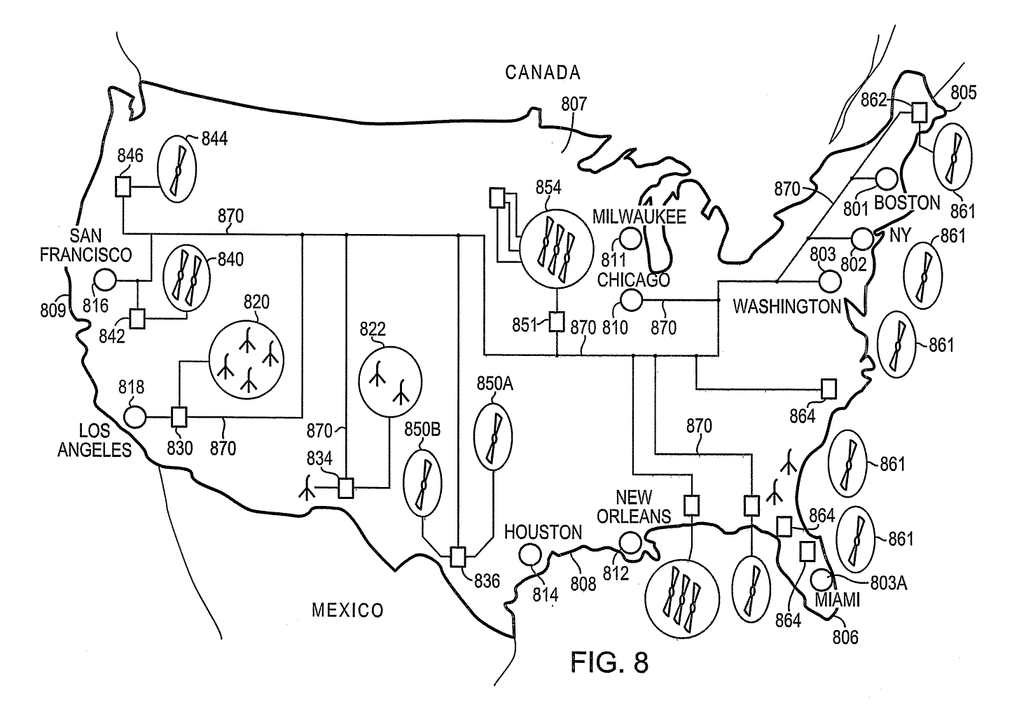

Turning now to FIG. 8, there is shown a sketch map of The USA with a few cities indicated. Boston 801, New York 802, and Washington, D.C. 803 are indicated along the East Coast 805. Miami 804 is indicated in Florida 806. Chicago 810 and Milwaukee 811 are indicated in the Northern Midwest 807. New Orleans 812 and Houston 814 are indicated along the Gulf Coast 808. San Francisco 816 and Los Angeles 818 are indicated along the West Coast 809.

Solar energy generators 820, 822 are indicated in regions of the United States where solar insolation is believed to be highest. Solar energy generators are indicated in the southwest desserts of California, Arizona, New Mexico, Nevada, etc. The California, Arizona, and New Mexico solar energy generators are representatively indicated to be connected to battery installations 830 located on the California coast. Solar energy generators 822 located in the Southwest, particularly in Texas, are indicated to be connected to battery installations 834, 836 located along the Gulf Coast.

Wind farm turbines 840 are indicated to be installed in the California mountains and connected to battery installation 842 located near the West Coast. Wind farm turbines 844 are indicated to be installed along the northwest coast mountains, and to be connected to battery installation 846 which is along the Northwest Coast. Wind farm units 850A and 850B are located in Texas and are connected to battery installation 836 located along the Gulf Coast. Wind farm units 854 are connected to battery installation 851 which is located either along the Mississippi River, or along the shores of the Great lakes. Wind farm units 861 are located near the Atlantic Coast and are connected to battery installations 862, 864 located along the East Coast.

The battery units are connected to each other by electric power grid 870. Also, the cities Boston 801, New York 802, Miami 803A, New Orleans 812, Houston 814, Chicago 810, Milwaukee 811, San Francisco, and Los Angeles are all connected to electric power grid 870 and serve as customers for the electrical energy generated by the solar collectors and wind farms.

The battery installations are electrolysis units represented by FIG. 1, FIG. 2, and FIG. 3.

Additionally, the nuclear electric power generating plants and the fossil fuel electric power generating plants are not shown, but are each connected to the electric power grid 870. During nighttime these sources of electric power have their output energy stored in various battery installations located conveniently near to the sources of electrical energy.

The disclosure of FIG. 8 is a nationwide electric transmission grid. Such a grid can be operated at several hundred thousand volts to a million volts, or higher if materials and construction techniques permit. This grid receives electrical energy from solar, wind, fossil fuel, nuclear fuel, tidal, etc. type electric generating plants. Electrical energy not needed for immediate consumption at loads supplied by the grid is stored in battery installations such as the water-hydrogen-oxygen electrolysis battery disclosed in FIG. 1, FIG. 2, and FIG. 3. Electrical energy loads supplied by the grid are represented in FIG. 8 as cities of The USA. The battery units store energy produced by electrical energy generation units which intermittently generate electrical energy. When needed, the battery units supply electrical energy to the grid, and to the various electric loads.

An advantage of the system of the present disclosure is that the battery units are capable of storing grid quantities of electrical energy as hydrogen and oxygen, and then when needed, the hydrogen and oxygen are combined to produce needed electrical energy.

### 1.0 An Analysis of the Number of Solar Energy Collectors Needed to Supply the Electric Generating Capacity of the USA.

Order of magnitude calculations, showing that solar reflectors and electrical energy storage by electrolysis of water can supply the electrical energy generation capacity of The United States, are disclosed as follows. This section of the Specification is written with numbered sections in order to improve readability of the Specification.

### 2.0 An Exemplary Embodiment of the Invention

The USA generates approximately 5,000 Million Megawatthours of electrical energy per year.

### Facts:

The USA generated 4,147 MILLION MEGAWATT HOURS in 2007; and

The USA generated 4,119 MILLION MEGAWATT HOURS in 2008; as reported by the United States Department of Energy, Energy Information Administration, DOE/EIA Electric Power Annual January 2010, all disclosures of which document are incorporated herein by reference herein as if all disclosures of the document were fully set forth herein.

Assume that solar collectors will be placed in The USA Southwestern dessert as it is these areas of the United States that the solar insolation is greatest. Also, these areas have the best weather patterns for harvesting solar energy. These areas have few clouds and daily sunshine, for a large percentage of the days of a year.

Assume that there are 8 hours per day of good sunshine, on a yearly average, in the Southwestern USA Desert. This number may be too large, but this is only an order of magnitude calculation, and any overestimate may be compensated for by a conservative choice for the kiloWatts production of a Stirling engine in good sunlight.

A Stirling engine is a heat engine, such as a steam engine, which uses a working fluid which is fully enclosed within the boundary of the engine. A Stirling engine is named after Robert Stirling a Scottish inventor who designed a closed cycle air engine in 1816, as reported by the electronic encyclopedia Wikipedia at the link: http://en.wikipedia.org/wiki/Stirling_engine.

Assume, One 30 foot (10 meter) reflector plus Stirling engine produces 10 kiloWatt electrical in good sunlight. The value of 10 kiloWatt electrical production in good sunlight is conservative, as values as much as 25 kiloWatt electric per reflector have been reported.

### NUMBER OF SOLAR COLLECTORS NEEDED

8 hours/day*10 kiloWatts=80 kWhr

ONE REFLECTOR GENERATES 80 kWhr PER DAY
ONE REFLECTOR GENERATES 80*365=29,200 kWhr PER YEAR
Assume that The United States generates 5,000 million megaWatt-hours per year.

$$\begin{matrix}NUMBER OF REFLECTORS NEEDED = 5 , 000 MILLION MEGA Whr \text{/} \\ YEAR / 29 , 200 kWhr \text{/} YEAR \\ = 172 MILLION REFLECTORS\end{matrix}$$

### GENERATING CAPACITY IS

### GENERATING CAPACITY, MEGAWATTS

Hours/year=8*365=2,920 hours

IN MEGAWATTS=5,000 MILLION MEGAWATT HOURS/(8 h/day*365 DAYS/YEAR)
-->1,712 thousand megawatts

### Area Needed for Reflectors

### ASSUME FOOTPRINT OF 30 METERS×30 METERS, 900 SQUARE METERS

$$\begin{matrix}AREA NEEDED = 172 MILLION * 900 METERsq = \\ = 15.5 \; 10 ( 10 ) METERsq\end{matrix}$$

$$\begin{matrix}Side of Square = sqrt ( 15.5 \; 10 ( 10 ) \\ = 393 kilometers -- > 393 km \text{/} 1.6 km \text{/} mile \\ = 246 miles\end{matrix}$$

### ASSUME FOOTPRINT OF 10 METERS×10 METERS, 100 SQUARE METERS

$$Size of square needed = 246 / 3 = 82 miles$$

$$ASSUME FOOTPRINT OF 172 MILLION REFLECTORS IS == 100 MILES \times 100 MILES = 10 , 000 SQUARE MILES$$

### THAT IS, A GENERATING FIELD OF 10,000 SQUARE MILES IS NEEDED

### GENERATING FIELD SUBUNITS

TAKE SUBUNITS OF 10 MILES by 10 MILES
NEED 100 SUBUNITS

### EACH SUBUNIT IS RATED AT 17 THOUSAND MEGAWATTS

EACH GENERATING FIELD IS 17 TIMES A TYPICAL 1000 MEGAWATT NUCLEAR OR FOSSIL FUEL PLANT

### IF SUBUNIT GENERATING FIELDS ARE 1,000 MEGAWATT GENERATING FIELDS,

### NEED 1,712 GENERATING FIELDS, THIS IS 34 GENERATING FIELDS PER STATE OF THE UNITED STATES

### 3.0 Land Area in Southwest USA Desert

Areas of Southwestern Deserts of The USA were taken from The World Almanac 2010, all disclosures of which document are incorporated by reference herein as if all disclosures of the document were fully set forth herein.
The desert areas are listed as:

| | |
|---|---|
| Chihuahuan, in Texas, New Mexico, | 140,000 square miles |
| Arizona, and Mexico, | |
| Death Valley, in California and Nevada, | 3,300 square miles |
| Mojave, in Southern California, | 15,000 square miles |
| Painted Desert in Arizona, small | |
| TOTAL Desert Area: = | 158,300 square miles |

Estimate land area suitable for generating fields between Rocky Mountains and the Mississippi River is approximately 200 miles by 500 miles=1,000,000 square miles

TOTAL land area suitable for generating fields, approximately =1,158,300 square miles

Conclusion

Only 10,000 square miles are needed to supply current electrical generating capacity of The USA. An area of 10,000 square miles is only a small fraction of the land area of the portion of The USA which has good solar insolation. If the electrical energy is first stored in a battery 104 as shown in FIG. 1, and if the battery is 50% efficient, then twice as many square miles are needed to be devoted to solar collectors to supply the electrical generating capacity of The USA. Also, if the battery is only 30% efficient, three times as many square miles are needed to supply the electrical generating capacity of The USA, or approximately 30,000 square miles.

4.0 Analyze a Storage Battery which First Converts Electrical Energy into Hydrogen and Oxygen by Electrolysis of Water, then Burns the Hydrogen with the Oxygen in a Gas Turbine to Make Water

### 4.1 Energy Storage by Electrolysis, Hydrogen Production

Electrolysis cells of 1970 textbook vintage are described, for example, by A. T. Kuhn, “Industrial Electrochemical Processes”, Elsevier, 1971, Chapter 4, all disclosures of which document are incorporated herein by reference as if all disclosures of the document were fully set forth herein.

An electrolysis cell, as described by Kuhn, using KOH electrolyte requires 4.5 kiloWatt hours of electrical energy to produce one cubic meter of hydrogen gas at STP.

$$In Joules , energy to make ( 1 ) one cubic meter H == 4.5 kWhr * 3.6 \; 10 ( + 6 ) J \text{/} kWhr = 16 , 200 kJoules$$

The chemical bond energy from burning hydrogen with oxygen is calculated as follows::

The volume of 1 mole of ideal gas is 22.4 liter, assume that hydrogen is an ideal gas

moles H in one cubic meter=1,000 Liters/22.4 L/mole=44.6 moles H

Heat of formation of water is 241.83 (gas) kJoules/mole
Hydrogen burns to make 44.6 moles of water,

$$\begin{matrix}Releasing heat of combustion = 241.83 kJ \text{/} mole * \\ 44.6 Moles ( Water ) \\ = 10 , 800 kJoules\end{matrix}$$

$$\begin{matrix}Efficiency of energy storage by electroysis = 10 , 800 kJ / 16 , 200 kJ \\ = 0.666 -- > 66.7 \%\end{matrix}$$

4.2 Gas Turbine Efficiency in Converting Hydrogen and Oxygen into Electrical Energy

The efficiency of operating a gas turbine by burning Hydrogen with Oxygen produced by electrolysis is:

efficiency=(Turbine Carnot efficiency)*machinery efficiency

Assume turbine temperature limit is 2,000 K

Assume Heat is rejected at 300 K

Assume machinery operates at 90% efficiency

Turbine efficiency=(1−300/2000)*0.9=0.765

### 4.3 Storage (Battery) Efficiency

$$\begin{matrix}Efficiency ( energy Storage and Release ) = electrolysis efficiency * \\ turbine efficiency \\ = 0.667 * 0.765 \\ = 0 , 51 -- > 51 \%\end{matrix}$$

That is, for every kilowatt hour input, storage will generate approximately one half kilowatt hour output

If all electricity produced is first stored as Hydrogen and Oxygen, then one must double the number of reflectors, so two 100 mile by 100 mile areas are needed to generate and store the electricity generated by the present day generation capacity of the Unites States of America.

### 5.0 Number of Reflectors Needed to Distill the Water for Electrolysis

The cost of distilling all water used to store the electrical generating capacity for one year is next estimated. It will become apparent from the calculation that the water must be recycled so that only fresh make up water must be distilled.

The following calculation is based on the assumption that freshly distilled for storing the electricity.

### 5.1. Latent Heat of Water and Heat Capacity of Water

$$Latent Heat of Vaporization kJ \text{/} kg = 2260 ( at 10 deg C . ) kiloJules \text{/} kilogram . \\ Specific heat of water C . ( p ) J \text{/} gK = 4.1813 ( 25 deg C . , and 100 deg C . )$$

$$\begin{matrix}1 kilowatt hour = ( 1 ) J \text{/} sec ) * ( 1 hr ) * ( 1000 Watt ) ( 3600 sec \text{/} hour ) \\ = 3.6 * 10 ( + 6 ) Joules\end{matrix}$$

$$\begin{matrix}Latent Heat of Vaporization of Water = 2260 J \text{/} g ) * ( 1000 g \text{/} kg ) * \\ ( 1 / ( 3.6 * 10 ( + 6 ) ) J \text{/} kWhr ) \\ = 0.628 kiloWatt Hour \text{/} kilogram\end{matrix}$$

$$\begin{matrix}Specific heat of water = 4.183 J \text{/} gram K * ( 1000 g \text{/} kg ) \\ = 4183 J \text{/} kg K \\ = ( 4183 J \text{/} kg K ) * ( \begin{matrix}1 / 3.6 * \\ 10 ( + 6 ) J \text{/} kWhr\end{matrix} ) \\ = 1.16 \; 10 ( - 2 ) kiloWatt hr \text{/} K kilogram\end{matrix}$$

$$\begin{matrix}energy to distill 1 kg of water = ( 0.628 + 1.16 \; 10 ( - 2 ) * ( 100 \text{-} 20 ) deg C . ) ) \\ kWhr \text{/} kg \\ = ( 0.68 + 0.928 ) kWhr \text{/} kg \\ = 1.56 kWhr \text{/} kg\end{matrix}$$

5.2. Number of Reflectors Needed to Distill the Water Electrolyzed by the Electricity Generated from One Reflector are Calculated as:
One reflector produces 80 kiloWatt hr/day of electrical energy
5.3 First, the kWhr Needed to Distill the Water Electrolyzed by One Reflector are:
4.5 kilowatt hours produce one cubic meter of hydrogen at STP

$$moles hydrogen is calculated as \text{:} 22.4 liter \text{/} mole ( ideal gas )$$

$$\begin{matrix}liters \text{/} cubic meter = 10 ( 6 ) cc \text{/} cubic meter \text{/} ( 100 cc \text{/} liter ) \\ = 10 ( 4 ) liter \text{/} cubic meter\end{matrix}$$

$$\begin{matrix}number cubic meters H \text{/} day = 80 Kwhr \text{/} day / \\ ( 4.5 kWhr \text{/} cubic meter ) \\ = 17.8 cubic meters @ STP\end{matrix}$$

$$\begin{matrix}number of moles H \text{/} day = 17.8 cubic meters at STP * \\ ( 10 ( 4 ) liters \text{/} cubic meter ) \text{/} 22.4 liter \text{/} mole ) \\ = 7 , 900 moles hydrogen \text{/} day\end{matrix}$$

### 5.4 Mass of Water Electrolyzed

density of hydrogen is 2 grams/mole

mass of hydrogen/day=2 grams/mole*(7,900 moles/day)=15 kg hydrogen/day

Mass of water needed to produce hydrogen
one mole of water gives one mole of hydrogen,
each mole of water is 18 grams of water

$$\begin{matrix}mass of water consumed per day = 7 , 900 moles hydrogen \text{/} day * \\ ( 0.018 kg \text{/} mole of water ) \\ = 142.2 kg water per day \\ per reflector\end{matrix}$$

$$kWhr needed to electrolyze 142.2 kg \text{/} water per day = 142.2 kg water * ( 1.56 kWhr \text{/} kg ) = 221 kWhr$$

$$\begin{matrix}Number reflectors needed = 221 kWhr \text{/} 80 kWhr \text{/} reflector \\ = 2.76 reflectors\end{matrix}$$

CONCLUSION need 2.76 reflectors to distill water for one reflector

### 5.5 Number of Reflectors to Distill the Water

$$total number reflectors needed to distill water for 160 million reflectors producing electricity = 160 million reflectors * 2.76 reflectors / reflector = 442 million reflectors$$

### 5.6 TOTAL Number of Reflectors Needed

$$\begin{matrix}TOTAL No . reflectors needed = = Number to make electricity + \\ number to distill the water \\ = 160 million + 442 million \\ = 602 million reflectors\end{matrix}$$

A conclusion of this order of magnitude calculation is that it is very expensive to distill all of the water which must be electrolyzed to store all of the electricity generated by solar energy production devices.

6.0 Recycle Water from Turbines to Electrolyzers

An order of magnitude calculation illustrating recycling water formed in the turbine from the chemical reaction of hydrogen and oxygen to form the water is next disclosed.

The gas turbine of the battery of FIG. 1, FIG. 2, and FIG. 3 creates water by reaction of the hydrogen and oxygen, this water is referred to as “turbine water”. The turbine water is relatively pure and can be filtered and returned to the electrolyzers without further distillation. Recycling turbine water greatly reduces the cost of distilling raw input water. Raw input water is taken from an ocean, a river, a lake, from a well, etc.

Suppose that each reflector produces 25 kw*8 hr/day=200 kWhr/day

$$reflectors needed to produce 5 , 000 million megwatt hours \text{/} year is = 5 \; 10 ( + 15 ) Whr = 5 \; 10 ( 12 ) kWhr$$

Using a 10 kW reflector makes, 80 kWhr/reflector per day.

$$\begin{matrix}reflectors needed = 5000 \; 10 ( 9 ) kWhr \text{/} year \text{/} \\ ( 80 kWhr \text{/} day * 360 days \text{/} year ) ) \\ = 174 million reflectors\end{matrix}$$

Using a 25 kw reflector makes, 200 kWhr/reflector per day.

$$\begin{matrix}reflectors needed = 5000 \; 10 ( 9 ) kWhr \text{/} year \text{/} \\ ( 200 kWhr \text{/} day * 360 days \text{/} year ) \\ = 69 million reflectors\end{matrix}$$

With recycling turbine water into the electrolyzer as shown in FIG. 2 and FIG. 3, it will only be necessary to distill enough water to fill the plumbing of a battery installation, as shown in FIG. 8, and then to distill enough water to make up for water lost from the system. Recycling turbine water to the electrolyzer reduces the amount of water which needs to be distilled.

Recycling turbine water to the electrolyzer is the preferred embodiment of the invention.

### 7.0 A Further Embodiment of the Invention

The presently disclosed system may be used for electrical energy storage for energy production methods which have the characteristic of intermittent energy production. For example, solar collectors quit working when the sun sets, when clouds shade the solar collector, etc. Both photovoltaic semiconductor cells and a heat engine such as a Stirling Engine discussed above are intermittent energy production techniques. Wind electrical energy production is intermittent as sometimes the wind blows, and sometimes the wind does not blow. Tidal energy production is another intermittent electrical energy production method, as it produces energy as the tides are either rising, or falling, etc. All of these intermittent energy production methods need electrical energy storage, and the use of electrolysis of water to produce hydrogen and oxygen can be usefully employed to provide the electrical energy storage needed.

A utility scale solution to Solar generation of electrical energy in the U.S.A. is to use reflectors to drive a heat engine which turns an electric generator. A storage system, battery, uses an electrolysis cell for water to produce hydrogen and oxygen, and the hydrogen and oxygen is used as fuel for operation between sunset and dawn.

### 7.1 Order of Magnitude Numerical Estimates

Order of magnitude numerical estimates are used to illustrate that the electrical consumption of The United States can be generated from Solar collectors in a small fraction of The USA land area. Also, energy storage by electrolysis of water and storage of the hydrogen and oxygen produced by electrolysis, with use of gas turbines to combine the hydrogen and oxygen to generate electricity, is illustrated by the order of magnitude numerical estimates.

### 7.2 Overview

A utility scale solution to Solar generation of electrical energy in the U.S.A. is to use reflectors to drive a heat engine which turns an electric generator. A storage system, battery, uses an electrolysis cell for water to produce hydrogen, and the hydrogen is used as fuel for operation between sunset and dawn.

D. Abbott discusses a solar energy system at the article: D. Abbott, “Proc. IEEE Vol. 98 Issue 1, pages: 42-66”, January (2010), all disclosures of which document are incorporated herein by reference as if all disclosures of the document were fully set forth herein. In the article, D. Abbott describes an exemplary Solar to electricity system using about 30 foot parabolic reflectors to operate a closed cycle heat engine (Stirling Engine). A Stirling Engine is further described at the document “Stirling Energy Systems—Sandia, 2008 news release: “Stirling Energy Systems—Sandia National Laboratory, 2008 news release”, link at: https://share.sandia.gov/news/resources/releases/2008/solargrid.html, all disclosures of which documents are incorporated herein by reference as if all disclosures of the documents were fully set forth herein.

Other shaped solar heat collection geometries have been used and will work with the electrolysis battery described herein.

An estimate of the number of such units needed to produce the approximately 4,200 million megaWatthours generated in the U.S.A. per year, is disclosed, where the 4,200 million megaWatthours is given by DOE/EIA, document entitled “Electric Power Annual” at “DOE/EIA Electric Power Annual January 2010”, DOE/EIA-0348 (2008), all disclosures of which document are incorporated herein by reference as if all disclosures of the document were fully set forth herein.

Assume that an electrochemical cell produces 1 cubic meter of hydrogen at STP by consuming 4.5 kiloWatt hours, as was disclosed by A. T. Kuhn in the textbook “Industrial Electrochemical Processes”, Elsevier, 1971, all disclosures of which document are incorporated herein by reference as if all disclosures of the document were fully set forth herein are discussed herein below.

The U.S.A. used 4,147 million megaWatthours in 2007, and the U.S.A. used 4,119 million megaWatt hours in 2008, “DOE/EIA Electric Power Annual January 2010, DOE/EIA-0348 (2008)”, all disclosures of which document are incorporated herein by reference as if all disclosures of the document were fully set forth herein.

For the purposes of numerical estimates of the present Specification, we assume that The USA needs 5,000 million megaWatt hours/year:

$$= 5 * 10 ** ( 15 ) watt hours$$

NOTE: the symbol ** means to raise to the power.
10**(15) means ten to the fifteen power

A single * between numbers means multiply.

A slash/between numbers means divide.

This Specification uses units of energy of WattHour (Whr), kiloWattHour (kWhr), or MegaWattHour, and Joule.

Electric power, which is energy used or made per unit time, is the Watt.

### 7.3 One Solar Reflector

The electrical energy, in Watt hours, generated by one 30 foot diameter solar reflector with an attached Stirling engine is estimated.

Solar insolation of 300 Watts per square meter is disclosed by Abbott in the American Southwestern Desert at ground level.

For this order of magnitude calculation it is conservatively assumed that Solar insolation is 100 Watts per square meter.

Assume that the efficiency of conversion to electric power=30%, also as is disclosed by Abbott.

A representative circular reflector is 30 feet in diameter and is parabolized to improve its focus. The diameter is 10 meters, and the radius is 5 meters.

area=pi*R**2=3.1415*(5)**2=78.5 sq meters

The 300 Watts per square meter insolation times a 30% conversion efficiency to electrical energy gives 90 Watts per square meter. For this order of magnitude demonstrative calculation it is assumed that each reflector gives 100 Watts per square meter of electrical energy.

$$\begin{matrix}Sunlight energy per reflector = 100 watt \text{/} meter sq * 78.5 sq meters \\ = 7 , 850 watt \text{/} reflector \\ = 7.85 kWhr per reflector\end{matrix}$$

Alternatively, Compute: electric power per reflector, assuming that the reflector is a square 30 feet×30 feet (10 meters×10 meters) The area is 100 sq meters.

$$the sunlight energy per reflector is approximately = 100 Watt \text{/} sq meter * 100 sq meters = 10 kw \text{/} reflector$$

The reflector focuses Solar energy onto a working fluid in a pressure capsule at the focus of the reflector to heat the working fluid. The heated working fluid then operates a heat engine. The working fluid is maintained in a closed cycle arrangement, and is therefore a Stirling engine. The Stirling engine is discussed in The Wikipedia at the link en.wikipedia.org/wiki/Stirling_engine.

A Stirling Energy Systems (SES) Press release dated Jan. 22, 2010 claims 25 kw per reflector instead of the above 7.85 kw per reflector, or the above 10 kw per reflector, as disclosed by the document Sandia National Laboratory Press Release, 28 Apr. 2010, and the document Stirling Energy Systems (SES) Press Release, at the link: www.stirlingenergy.com/press-room.htm, all disclosures of which documents are incorporated herein by reference as if all disclosures of the document were fully set forth herein.

A conservative value of 10 kWatt per reflector unit is used in this order of magnitude calculation as an estimate of the power production of a Solar reflector 10 meters diameter and a Stirling engine.

Energy production per an 8 hour day of sunshine, and yearly energy production are next computed, as follows. The number of hours in a good day of sunshine varies with the seasons, latitude of the installation, etc. An 8 hour day is assumed as a representative number of hours of good sunshine.

$$electrical energy generated is 10 kw \text{/} reflector * 8 hours \text{/} day == 80 kWhr \text{/} day$$

For further analysis herein, assumes each reflector generates 80 kWhr/day.

An alternative geometry which has been used is a cylindrical reflector which has a pipe containing a working fluid placed along the axis of the cylinder. The working fluid then operates a Stirling engine. The required area of solar collector for a cylindrical reflector is about the same as is disclosed in this Specification.

A further alternative geometry is to have a plurality of reflectors focused on a single capsule holding a working fluid. The working fluid is therefore heated and operates a heat engine. The heat engine may be, preferably, a closed cycle heat engine, that is a Stirling Engine.

### 7.4 Number of Solar Reflectors Needed to Supply USA Kilowatt Hours

Number of 80 kWhr/day reflectors needed to supply U.S. Electricity for 8 hour generation days is calculated as follows:

$$\begin{matrix}kW hours generated per year = = 80 * 10 ** ( 3 ) Watt hr \text{/} day \\ per reflector * 365 days \text{/} year \\ = 3 * 10 ** ( 7 ) Watt hr \text{/} year \\ per reflector\end{matrix} \\ Number of reflectors needed to supply U . S . Electricity := = 5 * 10 ** ( 15 ) Watt hr \text{/} year \text{/} 3 * 10 ** ( 7 ) Watt hr \text{/} year per reflector = 5 \text{/} 3 * 10 ** ( 8 ) reflectors = 1.6 * 10 ** ( 8 ) reflectors = 160 million reflectors$$

The conclusion is that approximately 160 million reflectors of 10 meters diameter are needed to supply the assumed 5,000 million megawatt hours of electrical energy.

### 7.5 Land Area Needed to Supply USA Kilowatt Hours

Assume that each reflector requires an area of 30 meters×30 meters=900 sq meters

$$\begin{matrix}Area needed = = 900 sq meters * 160 million reflectors \\ = 14 * 10 ** ( 10 ) sq meters\end{matrix}$$

$$\begin{matrix}length of side of square for area = = sqrt ( 14 * 10 ** ( 10 ) ) \\ sq meters ) \\ = 3.8 * 10 ** ( 5 ) meters \\ = 380 kilometers\end{matrix}$$

Assume that the km to mile conversion is 1.6 km/mile.

### Convert to Miles:

assume that each reflector requires a footprint of 30 meters by 30 meters:

$$\begin{matrix}length ( in miles ) = 380 kilometers \text{/} 1.6 km \text{/} mile \\ = 238 miles\end{matrix}$$

If each reflector occupies a footprint of 10 meters×10 meters,

length=80 miles

An area per reflector of 30 meters by 30 meters is probably too large, and an area of 10 meters by 10 meters is probably too small of a footprint for each solar reflector—Stirling engine combination. So in this order of magnitude numerical calculation it is assumed that a median land area is needed to supply the electrical energy of The USA, and the median area is assumed to be 100 miles by 100 miles, or 10,000 square miles.

That is, this order of magnitude calculation indicates that 10,000 square miles of solar to electrical energy converters are needed to supply the yearly electrical energy generating capacity of The USA.

### 7.6 Land Area in Southwest USA Desert

Areas of Southwestern Deserts of The USA were taken from The World Almanac 2010, “The World Almanac 2010”, published by The New York Times, Copyright 2010 by Infobase Publishing, at Page 695 in a section entitled “Notable Deserts of the World”, all disclosures of which document are incorporated herein by reference as if all disclosures of the document were fully set forth herein.

The desert areas of the Southwestern USA are listed as:

| | |
|---|---|
| Chihuahuan, in Texas, New Mexico, | 140,000 square miles |
| Arizona, and Mexico, | |
| Death Valley, in California and Nevada, | 3,300 square miles |
| Mojave, in Southern California, | 15,000 square miles |
| Painted Desert in Arizona, small | |
| TOTAL Desert Area: = | 158,300 square miles |

The area of the Great Plains East of the Rocky Mountains is given in The Wikipedia in a document at the link http://en.wikipedia.org/wiki/Great_Plains, all disclosures of which document are incorporated herein by reference as if all disclosures of the document were fully set forth herein.

The area of Great Plains East of Rockies is given as approximately, 500 miles East-West; and 2,000 miles North South This statement of land area of the Great Plains appears too large and may include areas of Canada and Mexico, and so only 10% is assumed to be suitable for solar reflector Stirling engine installations.

$$\begin{matrix}Area = 500 miles * 2 , 000 miles \\ = 1 , 000 , 000 square miles\end{matrix}$$

Many areas of the Great Plains East of the Rocky Mountains are suitable for placement of Solar reflector energy generators, and the assumption for this order of magnitude calculation is that at least 10% of this land area is suitable. This assumption gives another 100,000 square miles suitable for installation of Solar reflector energy generators.

The land area needed for direct generation of the electrical load of 5,000 million megaWatts, as calculated above, is 10,000 square miles, and if all of the energy is converted into hydrogen and oxygen at 50% efficiency then 20,000 square miles are needed. If the efficiency of energy storage by electrolysis of water is only 30%, then 30,000 square miles are needed. The available land area is approximately 200,000 square miles, and so there is plenty of land for the Solar reflector electricity generators.

The conclusion is that there is plenty of Southwestern Dessert in The USA to supply all electrical energy needs of the country.

The problem becomes two problems of implementation, generating the electrical energy, and transporting it to load centers on the Atlantic and Pacific coasts, and the Midwest, and elsewhere.

Electric generation plants are usually rated by power output, that is in Watts, or more conveniently, in megaWatts.

A reasonable method of implementation is to build 1,000 megaWatt units. The number of such units needed to supply the 5,000 million megaWatt hours of electrical energy consumed per year are computed as:

$$number of 1 , 000 megaWatt units = megaWatt Hours per year \text{/} ( Hours in a year * 1 , 000 ) \\ Assume megaWatt Hours per year U . S . A . generation = 5 , 000 million megaWatt hours \text{/} year , \\ \begin{matrix}number of 1 , 000 megaWatt units = = 5 , 000 million megaWattHours \text{/} \\ year \text{/} ( 365 * 24 * 1000 ) \\ = 570 units of 1 , 000 megaWatts each\end{matrix}$$

This number is equivalent to about 11 power plants of 1,000 megaWatts each per state of the 50 states in the U.S.A.

Nuclear electric power plants were sized to be about 1,000 megaWatts electric and 3,000 megaWatts thermal, and so solar electric generation units of 1,000 megaWatts each is a reasonable standard unit.

### 7.7 Energy Storage by Electrolysis

This order of magnitude numerical calculation describes storage of electrical energy by electrolysis of water to generate hydrogen and oxygen, and then combining the hydrogen and oxygen using a turbine to generate electricity.

The following discussion of electrolysis of water is makes use of the 1971 textbook by A. T. Kuhn, “Industrial Electrochemical Processes” which was incorporated by reference hereinabove. At Kuhn's Chapter 4, page 127 entitled “Industrial Water Electrolysis”, Kuhn discusses several commercial electrolysis units, See Kuhn beginning at Page 136, Sec. 6.1 “Tank Electrolysers”.

Kuhn presents a number of commercial water electrolysis units operating at atmospheric pressure, and a few units operating at elevated pressure. Kuhn rates the electrolyzers in terms of the number of kiloWatt hours of electrical energy consumed to produce one cubic meter of hydrogen at Standard Conditions of Temperature and Pressure (STP), taken to be one atmosphere pressure at 273 Kelvin.

7.8 Table 1 Below Sets Out Kuhn's Electrolysis Exemplars, all of which Use KOH Electrolyte, Operating at One Atmosphere Pressure.

TABLE 1
A summary of Kuhn's exemplar atmospheric water
electrolysis cells follows.
Commercial Electrolysis plants
Operating at Atmospheric Pressure

| Kuhn Section | Type | kWhr per cubic meter at STP |
|---|---|---|
| 6.1.1 | Knowles | 4.15 |
| 6.1.2 | Stuart | 4.9 |
| 6.2.1 | CJB | 4.75 |
| 6.2.2 | Demag | 4.3-4.5 (avg. 4.4) |
| 6.2.3 | Oerlikon | 4.3-4.4 (avg. 4.35) |
| 6.2.4 | Pintsch Bamag | 4.5 |
| 6.2.5 | Moritz | 4.4 |
| 6.2.6 | De Nara | 4.6 |

AVERAGE = 4.5 kWhr per cubic meter at STP

Kuhn also discusses high pressure water electrolysis units, such as a commercial model: Zdansky-Lonza which produces electrolysis at 30-200 atmospheres pressure. Power Consumption: 7.2 kWhr per cubic meter of hydrogen at STP.

### 7.9 Calculate Efficiency of Conversion of Electrical Energy to Hydrogen Chemical Bond Energy.

Calculate Efficiency of conversion of electrical energy to hydrogen chemical bond energy in molecular hydrogen.

First, calculate the number of Joules of energy needed to electrolyze water to produce one mole of hydrogen at STP.

$$Joules = kWhr * ( Joule \text{/} sec per Watt ) * ( 1 , 000 Watt ) * ( 60 min \text{/} hr ) * ( 60 sec \text{/} min )$$

$$Joules = kWhr * 3.6 * 10 ** ( 6 ) Joules \text{/} kWhr 4.5 kiloWatt hours are converted as , \\ \begin{matrix}Joules ( 4.5 kWhr ) = = 4.5 kWhr * 3.6 * 10 ** ( 6 ) Joules \text{/} kWhr \\ = 1.62 * 10 ** ( 7 ) Joules\end{matrix}$$

Second, compute the energy released, in Joules, in oxidation of one cubic meter of hydrogen with oxygen.

Convert 1 one cubic meter of Hydrogen at STP, to moles of hydrogen.

Density of hydrogen at STP=0.0899 grams/liter:

as given by the document “CRC handbook of Chemistry and Physics, Edition 36, 1954”, all disclosures of which document are incorporated herein by reference as if all disclosures of the document were fully set forth herein.

(assume STP is 273 K, 1 atmosphere, V in liters,
One cubic meter is 1,000 liters.

$$\begin{matrix}mass of 1 , 000 liters = 0.0899 * 1 , 000 \\ = 89.9 grams\end{matrix}$$

One mole of ideal gas occupies 22.4 liter at STP

$$\begin{matrix}Moles = mass \text{/} MW \\ = 89.9 \text{/} 2 = 44.9 Mole\end{matrix}$$

$$1000 liter \text{/} 22.4 liter \text{/} mole at STP = 44.6 moles$$

Heat of formation, enthalpy of formation Water (gas)=241.83 kJ/mole:

as given in the document by Gordon M. Barrow, “Physical Chemistry”, Sixth Edition, McGraw Hill, 1996, all disclosures of which document are incorporated herein by reference as if all disclosures of the document were fully set forth herein.

$$\begin{matrix}TOTAL heat of formation = = 241.83 * 10 ** ( 3 ) J \text{/} Mole * 44.6 Mole \\ = 1.0785 * 10 ** ( 7 ) J\end{matrix}$$

The heat energy liberated by reacting hydrogen with oxygen, per mole of hydrogen, is equal to the heat of formation of water.

The efficiency of converting 4.5 kWatHr into chemical bond energy is given as:

$$\begin{matrix}efficiency = ( TOTAL heat of formation ) \text{/} ( electrical energy used ) \\ = 4.5 kWhr for one cubic meter of hydrogen \\ ( in Joules ) / ( Heat of formation of water in Joules \\ from one cubic meter of hydrogen ) = \\ = 1.0785 * 10 ** ( 7 ) J \text{/} 1.62 * 10 ** ( 7 ) J \\ = 0.666 \\ = 66.6 \%\end{matrix}$$

Another source for the electrical energy required to form one cubic meter of hydrogen at STP is an analysis by C. L. Mantell in the document by C. L. Mantell, “Electrochemical Engineering, McGraw Hill, 1960”, and is given at his Chapter 12, Pages 308-320, “Hydrogen, Oxygen, and Deuterium”, all disclosures of which document are incorporated herein by reference as if all disclosures of the document were fully set forth herein. At page 316 Mantell mentions a Zdansky-Lonza pressure electrolyzer which is claimed to produce hydrogen at 450 pounds per square inch while consuming 4.3 kilowatt hours per cubic meter of hydrogen, with the hydrogen referred to conditions at STP.

### 7.10 Amount of Water Needed to Store One Year of U.S.A. Electrical Generation Energy

4.5 kWhr produces one (1) cubic meter of hydrogen, which is 44.6 moles of hydrogen.

When oxidized, one mole of hydrogen produces one mole of water.

one mole of water weighs 2+16=18 grams.

Weight of water consumed in electrolysis by 5,000 million megaWatt Hours of electrical energy is calculated as follows:

$$\begin{matrix}cubic meters of hydrogen produced = = ( 5 , 000 million mega Watt \\ Hours ) / ( 4.5 kWhr per cubic \\ meter of H ) ) \\ = 1 , 111.1 * 10 ** ( 9 ) cubic meters \\ of hydrogen at STP\end{matrix}$$

Number of moles of hydrogen produced are calculated as:
Each cubic meter of hydrogen is 44.6 moles.

$$\begin{matrix}Number moles of hydrogen = = ( 1 , 111 * 10 ** ( 9 ) cubic meters H ) * \\ ( 44.6 moles H per cubic meter ) \\ = 4.95 * 10 ** ( 13 ) moles of hydrogen\end{matrix}$$

Also, the same number of moles of water are consumed in producing the moles of hydrogen.

$$number of moles of water consumed == 4.95 * 10 ** ( 13 ) moles of water$$

$$\begin{matrix} weight of water consumed is = = 4.95 * 10 ** ( 13 ) moles * \\ 18 grams \text{/} mole \\ = 8.91 * 10 ** ( 14 ) grams = \\ = 8.91 * 10 ** ( 11 ) kilograms\end{matrix}$$

$$the density of water is 1 gram \text{/} milliliter = 1 Kg per liter , \\ the volume of water consumed is == 8.91 * 10 ** ( 11 ) liter$$

$$Convert liters of water consumed to gallons , one gallon = 3.785 liter$$

$$\begin{matrix} Gallons of water consumed = 8.91 * 10 ** ( 11 ) liter \text{/} 3.785 \\ liter \text{/} gallon = \\ = 2.35 * 10 ** ( 11 ) gallons \\ = 235 , 000 million gallons in one \\ year of electrolysis .\end{matrix}$$

A problem is that there are not 235,000 million gallons of water available each year in the Southwest USA desert. One exemplary solution is to have transmission lines from the solar collectors to the seashore, take water from the ocean, and electrolyze the ocean water after desalination. See Abbot, as incorporated by reference hereinabove. The California coast and the Texas coast on the Gulf of Mexico are reasonable locations for locating electrolysis plants to store electrical energy generated in the Southwest dessert.

The energy required for transmission to the coast and to desalinate the ocean water will require more Solar reflector collectors. However, there is plenty of desert to accommodate the solar collectors, especially when the electrolyzed is re-circulated after the hydrogen and oxygen are re-combined in a gas turbine to form turbine water.

Also electrolysis of water is a reasonable energy storage method for wind farms, to supply electricity when the wind is not blowing.

7.11 Amount of Water which Must be Electrolyzed to Store One Day of Electrolysis in a 1,000 megawatt Battery

Amount of water needed to store a 1000 megawatt input for one day, one week, or one month is calculated by the order of magnitude calculation, as follows.

A 1000 megawatt input for 24 hours gives 24,000 megawatt hours of energy to store in the battery

$$The cubic meters of hydrogen produced are == 24 , 000 megawatt hours * 1000 kilowatts \text{/} megawatt \text{/} 4.5 kWhr per cubic$$

$$meter == 5.33 * 10 ** ( 6 ) cubic meters$$

$$Each cubic meter of hydrogen is 44.6 moles . \\ \begin{matrix}Number moles of hydrogen = = ( 5.33 * 10 ** ( 6 ) cubic meters H ) * \\ ( 44.6 moles H per cubic meter ) \\ = 2.37 * 10 ** ( 8 ) moles of hydrogen\end{matrix}$$

$$the number of moles of water consumed are equal to the number of moles of hydrogen produced by electrolysis = 2.37 * 10 (* * 8 ) moles of water \\ \begin{matrix} weight of water consumed = ( 2.37 * 10 (* * 8 ) moles of water ) * \\ ( 18 grams / mole ) \\ = 4.27 * 10 ** ( 9 ) grams water \\ = 4.27 * 10 ** ( 6 ) kilograms of water\end{matrix}$$

The density of water is 1 kilogram per liter

$$the volume of water consumed is == 4.27 * 10 ** ( 6 ) liter$$

$$Convert liters of water consumed to gallons , one gallon = 3.785 liter$$

$$\begin{matrix}Gallons of water consumed = 4.27 * 10 ** ( 6 ) liter \text{/} 3.785 \\ liter \text{/} gallon = \\ = 1.13 * 10 ** ( 6 ) gallons\end{matrix}$$

That is, for 24 hours of full capacity operation of a 1,000 megawatt battery, there are electrolyzed 1.13 million gallons of water.

To hold the electrical energy stored in the battery after one week of full capacity operation, the amount of water electrolyzed is:

$$\begin{matrix} = 1.13 * 10 ** ( 6 ) gallons \text{/} day ) * ( 7 days ) \\ = 7.91 * 10 ** ( 6 ) gallons of water are electrolyzed for one week of \\ operation\end{matrix}$$

To hold the electrical energy stored in the battery after 365 days (one year) of operation, the amount of water electrolyzed is:

$$\begin{matrix} = 1.13 * 10 ** ( 6 ) gallons \text{/} day ) * ( 365 days ) \\ = 412 * 10 ** ( 8 ) gallons of water are electrolyzed for one \\ year of operation .\end{matrix}$$

That is, to store the electrical energy received by one 1,000 MegaWattHour battery during full capacity operation during one year of operation, 412 million gallons of water must be electrolyzed.

To compare this result with the previous result for storing one full year of USA electric generating capacity which requires 570 battery plants of 1,000 megawatt capacity, the total amount of water electrolyzed is:

$$\begin{matrix} = 412 * 10 ** ( 8 ) gallons of water per battery * 570 batteries \\ = 2.35 * 10 ** ( 11 ) gallons\end{matrix}$$

This number of gallons electrolyzed is in agreement with the value calculated above in Section 7.10 for the quantity of water needed to be electrolyzed to store the yearly generating capacity of the USA. The number of moles of hydrogen which must be stored are also given above for each battery for one day, etc. of full design limit operation of a 1,000 megawatt battery. The number of moles of oxygen which must be stored is one half the number of moles of hydrogen.

The design parameters for a battery as illustrated in FIG. 1, FIG. 2, and FIG. 3, in accordance with the invention, must be selected to accommodate these quantities of water which must be electrolyzed, and hydrogen and oxygen which must be stored for the design time of storage. For example, the design time of storage can be one day of storage, one week of storage, one year of storage, etc.

### 8.0 Hydrogen-Oxygen Fueled Turbine

Methane turbines are well known. The operating temperature must be maintained low enough to avoid damaging the turbine. The present proposal is to burn hydrogen with the pure oxygen produced by electrolysis, as heating nitrogen from the air in the presence of oxygen from the air is to be avoided. It may be necessary to add a working fluid such as steam to bring the burning temperature down to a maximum temperature that a turbine can withstand, about 2,000 Kelvin.

### 9.0 System Needed to Supply USA Yearly Kilowatt Hours

a. electricity generated in Southwest Dessert using solar collectors, either photovoltaics or reflectors which drive heat engines such as closed cycle steam engines, or other Stirling Engines.

b. transmission lines to seashore or other convenient body of water.

c. electrolysis plants on seashore or other convenient body of water, the water must first be purified, for example by distillation or filtration.

d. store the electricity by storing the hydrogen and oxygen produced by electrolysis.

e. generate electricity from turbines, fuel cells, or other process, the generation of energy from hydrogen and oxygen produces water, which we call “turbine water” for convenience of labeling.

f. re-circulate water formed in turbines, fuel cells, from reaction of hydrogen and oxygen in the turbine, where the recycled water is used in another round of electrolysis.

g. transmission of electricity to load centers

The efficiency of a hydrogen-oxygen turbine is next estimated.

$$turbine efficiency = ( Carnot efficiency ) * ( machinery efficiency )$$

$$Carnot efficiency = ( 1 - Tout \text{/} Tin )$$

$$Machinery efficiency , assume = 90 \% , using all waste heat in a multistage combined cycle arrangement of machinery$$

$$Turbine Efficiency = ( 1 - 300 K \text{/} 2 , 000 K ) * ( 0.9 ) = 0.77$$

$$\begin{matrix} Total efficiency = electrolysis efficiency * turbine efficiency \\ = 0.66 * 0.77 \\ = 0.50\end{matrix}$$

The disclosure of this order of magnitude calculation is that the efficiency of an electrolysis system with a hydrogen-oxygen turbine is around 50%.

### 10.0 HVDC Transmission Lines

An alternating Current (AC) transmission line needs to be phase and frequency synchronized with each AC grid to which it is attached. A High Voltage Direct Current (HVDC) transmission is an alternative. A further alternative is an AC transmission line, but a short DC line at each interconnection with an AC grid, so that the transmission line does not need to be phase and frequency synchronized with the grid. Cost and conversion efficiency are the limiting factors.

A 3,000 mile line at 0.5 Ohm per mile, with a 1,000 Ampere current flowing has a voltage drop of 150,000 Volts

A 750,000 Volt input in California will produce about 500,000 Volts in Boston or is New York. The power loss from 750 kV input to 500 kV output is a 33% loss, in energy units

### 11.0 Superconducting Transmission Lines

High temperature superconductors are materials which go superconducting when cooled by liquid nitrogen to a temperature around 70 degrees Kelvin. Superconducting wires can be used as transmission lines to bring electrical energy from the Southwestern Dessert area of the United States to convenient bodies of water. For example, the ocean can supply the water needed for electrolysis. Also the great Lakes of North America can supply the needed water. Further, any adequate sized body of water can supply the water needed for electrolysis to store electrical energy. For example, the dessert areas of California can have transmission lines to the Pacific Ocean, for example near San Diego, Calif. Dessert areas in Texas can have transmission lines to the Gulf of Mexico. Other southwestern dessert areas can have transmission lines either to the Pacific Ocean or to the Gulf of Mexico, whichever is most convenient.

Solar collectors or wind farm wind turbines in the Midwest can use water from the Great Lakes, from the Mississippi River, or other inland rivers such as the Missouri River, the Snake River, etc., whichever body of water is most convenient.

### 12.0 Alternatives:

Ship hydrogen from California to Boston by: (1) railroad; (2) pipeline; (3) ocean going tanker; (4) other such as trucks, (5) use high temperature superconducting wires for transmission lines etc.

High temperature superconducting wires are available from a number of manufacturers, including American Superconducting, located at Devons, Ayer, Mass. High temperature superconductors are materials which have zero electrical resistance when cooled to about 70 Kelvin using liquid nitrogen.

### 13.0 Modular Nature of the System

Build one plant at a time, first service Western utilities, gradually develop systems to Midwest, Chicago, etc., then supply Eastern Markets, New York, Washington, Philadelphia, Boston, etc. Time Needed to Switch to 100% Modular program can unfold over 20-50 years. At first, build a few 1,000 Megawatt units with accompanying water electrolysis plants and use them for shakedown in order to find design problems.

Variations, modifications, and other implementations of what is described herein will occur to those of ordinary skill in the art without departing from the spirit and the scope of the invention as claimed. Accordingly, the invention is to be defined not by the preceding illustrative description but instead by the spirit and scope of the following claims.

1. An electrical energy storage system, comprising:
terminals to receive electric current;
an electrolyzer to send electric current received through the terminals through first water in order to produce hydrogen and oxygen from the first water;
a storage system to store the hydrogen;
a storage system to store the oxygen;
a turbine to receive hydrogen from the hydrogen storage system and to receive oxygen from the oxygen storage system and to combine the hydrogen and the oxygen to deliver energy to the turbine and for the turbine to operate an electric generator, and for second water to be formed in a chemical reaction between the hydrogen and the oxygen, the second water to be formed in a vapor phase;
a condenser to condense the second water from the vapor phase into a liquid phase as liquid second water; and
a pipe to deliver the liquid second water to the electrolyzer to be again electrolyzed into new hydrogen and new oxygen in order to recirculate the second water into the first water.

2. The apparatus as in claim 1, further comprising:
a purifier to accept new water from an ocean, to remove dissolved materials from the new water to make purified new water, and to deliver the purified new water to the electrolyzer to be electrolyzed into new hydrogen and new oxygen.

3. The apparatus as in claim 2, further comprising;
the purifier is a distillation unit.

4. The apparatus as in claim 1, further comprising:
a filter to receive the liquid second water from the pipe before the liquid second water goes to the electrolyzer, and after the liquid second water passes through the filter to make filtered liquid second water, and an outlet pipe to deliver the filtered liquid second water to the electrolyzer.

5. The apparatus as in claim 1, further comprising:
the electric current received at the terminals is alternating polyphase electric current;
a transformer to change a voltage of the polyphase electric current to a desired voltage; and
a rectifier to rectify the polyphase electric current at the desired voltage into direct current to deliver the direct current to the electrolyzer.

6. The apparatus as in claim 1, further comprising:
a solar electric production unit to generate solar electrical energy from solar irradiation;
a first transmission line to deliver the solar electrical energy to the electrical energy storage system at the terminals; and
a second transmission line to deliver output electrical energy from the electrical energy storage system to customers in a distant city,
wherein the solar electrical production unit is located in a dessert land area and the electrical energy storage system is located near a body of water which is used to supply the first water and the new water.

7. The apparatus as in claim 6, further comprising:
the body of water is an ocean.

8. The apparatus as in claim 6, further comprising:
the body of water is a river.

9. The apparatus as in claim 6, further comprising:
the body of water is a lake.

10. The apparatus as in claim 1, further comprising:
an electrical energy production unit to generate electrical energy;
a first transmission line to deliver the electrical energy to the electrical energy storage system at the terminals; and
a second transmission line to deliver output electrical energy from the electrical energy storage system to customers in a distant city.

11. The apparatus as in claim 10, further comprising:
the electrical energy production unit is a nuclear electric power plant.

12. The apparatus as in claim 10, further comprising:
the electrical energy production unit is a fossil fuel electric power plant.

13. The apparatus as in claim 10, further comprising:
the electrical energy production unit is a wind farm of wind operated electrical energy generating units.

14. The apparatus as in claim 10, further comprising:
the electrical energy production unit is a tidal electrical energy system which generates electrical energy from tidal motion of an ocean.

15. A method for operating an electrical energy storage system, comprising:
electrolyzing first water in order to produce hydrogen and oxygen from the first water;
storing the hydrogen;
storing the oxygen;
operating a turbine from the hydrogen and the oxygen to combine the hydrogen and the oxygen to deliver energy to the turbine for operating an electric generator to generate electrical energy and forming second water in a chemical reaction between the hydrogen and the oxygen, the second water being formed in a vapor phase;
condensing the second water from the vapor phase into a liquid phase as liquid second water; and
delivering the liquid second water to be electrolyzed into new hydrogen and new oxygen in order to recirculate the second water into the first water.

16. The method as in claim 1, further comprising:
removing dissolved materials from new water to make purified new water, and delivering the purified new water to an electrolyzer as the first water.

17. The method as in claim 16, further comprising;
distilling the new water to make the purified water.

18. The method as in claim 1, further comprising:
filtering the liquid second water before delivering the liquid second water to an electrolyzer.

19. The method as in claim 1, further comprising:
changing polyphase electric current into a desired voltage; and
rectifying the polyphase electric current at the desired voltage into direct current to deliver the direct current to the electrolyzer.

20. (canceled)
